(19) United States
(12) Patent Application Publication
(10) Pub. No.: US 2014/0345653 A1
(43) Pub. Date: Nov. 27, 2014

(54) DEVICE AND METHOD FOR CLEANING CONTAINERS

(71) Applicant: David Kutschke, Kiel (DE)

(72) Inventor: David Kutschke, Kiel (DE)

(73) Assignee: KRONES AG, Neutraubling (DE)

(21) Appl. No.: 14/221,759

(22) Filed: Mar. 21, 2014

(30) Foreign Application Priority Data
Mar. 21, 2013 (DE) 102013102916.7

(51) Int. Cl. B08B 9/22; B08B 9/08

(52) U.S. Cl. CPC B08B 9/22; B08B 9/083
USPC 134/23; 134/166 R; 134/22.1

(57) ABSTRACT

A device for cleaning containers, such as for cleaning returnable bottles in a beverage filling plant, comprises a main treatment area, in which the containers are treated by means of a main lye, and a post-treatment area, in which the containers are treated with a water bath or post-lye bath and rinsed with water, wherein in the post-treatment area, a flushing device is provided for removing labels and/or residues of labels.

### CROSS-REFERENCE TO RELATED APPLICATION

This application claims priority from German Patent Application No. 10 2013 102 916.7, filed on Mar. 21, 2013 in the German Patent and Trademark Office, the disclosure of which is incorporated herein by reference in its entirety.

### FIELD OF THE INVENTION

The present invention relates to a device and a method for cleaning containers, such as for cleaning returnable bottles in a beverage filling plant.

### RELATED ART

Cleaning devices for cleaning containers in beverage filling plants are known. In these devices, the extent of cleaning that is necessary varies according to the degree of contamination of the containers that are brought into the device. Returnable bottles can be heavily contaminated, due to incorrect storage or the introduction of foreign matter such as cigarette ends, and thus care must be taken to remove the foreign matter that contaminates the returnable bottles in this manner. Before the returnable bottles are used again, it is also necessary to detach any labels adhering to their outer surfaces, and thereby provide bottles that are fully cleaned both internally and externally for renewed filling, capping and labeling processes.

To perform these cleaning tasks, cleaning machines are known which can be operated continuously, and in which the containers to be cleaned usually pass through several cleaning zones. There is usually a pre-cleaning area, in which the containers to be cleaned are first fully emptied, allowing residues of product to drip out and removing loose material from the containers. In this pre-cleaning area, the bottles are usually also flushed with jets of water or lye, and pretreated externally and internally using a so-called pre-soak or pre-lye. At the same time, the bottles are pre-warmed for their further treatment, in order to prevent the occurrence of stress rupture.

In the subsequent main treatment area, the containers to be cleaned are again treated with the so-called main lye. Here the containers are immersed in a lye bath, agitated within, and then lifted out of the lye bath. In the process, the interior space of each bottle is completely filled and then drained. In combination with this, the containers can be additionally sprayed with jets of the main lye or flushed with the main lye, in order to employ additional mechanical cleaning forces, and/or dislodge stubborn contamination by means of the impulse applied.

After passing through the main treatment area, the containers that are to be cleaned are post-treated in a post-treatment area, in which they usually first pass through a so-called post-lye as a final lye rinse. The containers are then rinsed with pure water, which also cools them, and, after substantially complete draining or emptying by dripping, they are discharged from the cleaning machine.

The geometry of the cleaning machines differs between double-end cleaning machines and single-end cleaning machines. In a double-end cleaning machine, the stream of containers to be cleaned enters the cleaning machine at one end of the cleaning machine, passes through the pre-treatment area, the main treatment area and the post-treatment area inside the cleaning machine, and then leaves on the other side of the cleaning machine to pass on for further processing. In a single-end cleaning machine the containers to be cleaned enter on one side of the cleaning machine, pass through the pre-treatment area, the main treatment area and the post-treatment area inside the cleaning machine, and then, after cleaning, leave on the same side of the cleaning machine as that on which they entered the cleaning machine in order to be cleaned.

In the known cleaning machines, the active detaching and removal of labels takes place in the main treatment area. Here, the removal of the labels is preferably aided by the application of a flushing action to the containers, preferably with the flow of fluid directed out of the transport basket or transport pocket in which each container is conveyed. By this means, the labels that were detached by dipping in the lye baths are flushed out of each container basket or container pocket, then in turn removed from the main treatment area by means of a label removal device disposed in the corresponding lye bath. The label removal device of the corresponding lye bath can be combined with a glass fragment removal device.

Because the labels use differing adhesives, differing types of paper, differing printing inks and differing glues, it can occur that when the containers are passed through the main treatment area the labels are detached only at a late stage or not detached at all. This is particularly the case when specialized combinations of adhesive, labels and printing inks are used, which are designed for example for use with bottles that are to be kept by end users for longer periods in an ice bath without the labels falling off. As a result, labels are carried into the post-treatment area, and cannot there be removed from the container baskets or container pockets.

In the post-treatment area, the labels that nevertheless are still on the containers or in the container baskets or container pockets can no longer be reliably removed.

In conventional bottle cleaning machines, the removal of labels during the main treatment, i.e. in the main treatment area, is not adequate in all cases. With various combinations of bottles, labels and adhesives, it can occur that the bottles or a portion of the bottles to be cleaned pass through the main treatment area without the labels being removed completely, or without them being removed at all. In the subsequent treatment zones, however, in particular the post-treatment zone in which the residues of cleaning lye are removed by spraying, it is not possible to remove labels, with the result that disruptions can occur in these areas of the plant if the labels have not been previously removed completely in the main treatment area. Furthermore, it can occur that labels are carried beyond the water zones to the outlet from the cleaning device.

### SUMMARY

Accordingly, embodiments of the present invention provide a device and a method for cleaning containers, enabling improved cleaning of the containers.

In one embodiment, a device for cleaning containers, such as for cleaning returnable bottles in a beverage filling plant, comprises a main treatment area, in which the containers are treated by means of a main lye, and a post-treatment area, in which the containers are treated in a water bath or post-lye bath, and rinsed with water. According to one embodiment, in the post-treatment area, a flushing device is provided for removing labels and/or residues of labels.

Because a flushing device is provided in the post-treatment area, it is possible to extend to the maximum the application time or treatment time of the lye and/or cleaning fluids to which the containers are exposed in each of the prior treatment phases, so that even labels which are difficult to detach can be reliably removed after the maximum application time. Furthermore, in order to remove conventional labels, the cleaning device can be appropriately shortened, thereby enabling the plant as a whole to be operated more efficiently, since investment costs, operating costs and processing times can be reduced.

By means of the flushing device for removing labels and/or residues of labels which is disposed in the post-treatment area, it is possible in conventional designs of the cleaning device also to remove problem labeling, for example labeling which is intended to withstand storage of the applicable bottles in iced water for several hours. To achieve this, it is not necessary to lengthen the cleaning device; instead, the longer application time of the lye and other cleaning fluids is achieved by disposing the flushing device as late as possible in the process, since after a maximum application time, the removal of the labels can then be achieved by flushing them away.

Furthermore, glass fragments and dirt can also be removed in this manner from the post-treatment area.

The flushing device is disposed, in one embodiment, in a post-lye bath or a water bath in the post-treatment area. By this means the construction of a device for cleaning can be achieved by the use of already known components of the plant. Additionally, by this means the impulse can be applied by agitation of the fluid in the flushing device as late as possible, so that reliable removal of the labels after a maximum application time can be achieved.

The flushing device is configured, in one embodiment, to generate a directed flow of fluid in a post-lye bath to flow around the containers, and particularly, in one embodiment, configured to generate a directed flow of fluid out of a container basket or container pocket which holds in each case one container. By means of appropriate direction of the fluid flow, it is possible to achieve the flushing of labels away from the containers, and the flushing of labels out of, or away from, the container basket or container pocket. In this manner, other foreign matter in the container pocket or container basket can also be flushed out of the pocket or basket.

In one embodiment, the flow applied by means of the flushing device is directed such that it aids the removal of the labels from a container basket or container pocket. For this purpose, the flow is directed towards the aperture of the applicable container basket or container pocket, such as downwards from above, so that the detached labels are flushed out of the container pocket or container basket.

In order to enable the labels detached by the flushing device to be removed from the post-treatment device, the flushing device is, in one embodiment, connected with a label removal device for removing detached labels from the post-treatment area. The label removal device can be disposed for example opposite the flushing device, such as in the direction of flow of the fluid applied by the flushing device, so that the flushed-away labels are flushed into the label removal device.

In order to encompass all containers that are to be cleaned by the device, the flushing device, in one embodiment, has at least one nozzle for each container position, such as for each container pocket position or container basket position, across the width of the machine. This enables an appropriately directed fluid flow to be maintained at each container position, container pocket position or container basket position, such that, as each container, container pocket or container basket passes through, the fluid flow can flush away the corresponding labels and rinse out the container baskets or container pockets. In one embodiment, the device comprises a larger number of nozzles at each container position, for example two, three or five nozzles, which are each configured to generate the flow that is directed outwards from the container basket or container pocket, so that this flow can be maintained along the entire length of a certain transport path of the containers.

To apply the flow generated by the flushing device, such a nozzle, or such a plurality of nozzles, may emit the fluid flow below the fluid level in a lye bath or a water bath, in order to reduce the formation of foam. The nozzles, in one embodiment, emit the flow of fluid downwards, in order for the fluid flow to act directly on the container baskets or container pockets in a downward direction and thereby enable the labels to be flushed out of each container basket or container pocket in a downward direction, in order to achieve reliable and efficient flushing out of the labels.

In one embodiment, a bottle grid is provided, which is disposed below the flushing device, such that a directed fluid flow from the flushing device is directed onto the bottle grid. By this means, the flushing out of detached labels and other foreign matter can be achieved, with the labels and foreign matter being removed from the post-treatment area via the bottle grid.

In an additional embodiment, the flushing device is combined with a glass fragment removal device, such that detached labels are removed in the area of the glass fragment removal device. In this manner, existing components can be used to improve the cleaning.

A tripping step is provided in one embodiment, which enables the tipping of the containers disposed in container pockets or container baskets, wherein the tripping step is disposed in the area of the flushing device. By means of the tripping step, which can also be configured as a displacement elevation, the containers accommodated in individual container baskets or container pockets are tipped or displaced within the container pocket or within the container basket, in such a manner that labels or other foreign matter that may be trapped between the container and the container pocket or container basket are released, and can then be flushed away by the flushing device.

The device can be used in both a double-end machine and a single-end machine. In one embodiment, only the rinsing of the then fully cleaned containers with pure water is performed following the flushing device, so that the removal of the labels by means of the flushing device takes place at the latest possible moment in the treatment sequence.

In this manner the quality of the cleaning of the containers that are cleaned can be further improved, so that the lowest possible amount of additional extraneous material or hazardous substances is carried forward into the subsequent processing stages.

Accordingly, a method for cleaning containers, preferably for cleaning returnable bottles in a beverage filling plant, is proposed, comprising a main treatment which is carried out in a main treatment area, in which the containers are cleaned by means of a main lye, and a post-treatment in a post-treatment area, in which the containers are treated with a post-lye or water and rinsed with water. According to various embodiments, in the post-treatment area, labels and/or residues of labels are removed from the containers, container pockets and/or container baskets by a flushing device.

### BRIEF DESCRIPTION OF THE DRAWINGS

Various embodiments and aspects of the present invention are more fully explained by the description below of the figures. The figures show:

FIG. 1 is a schematic representation of a device for cleaning containers according to one embodiment;

FIG. 2 is a schematic perspective representation of a post-treatment area according to one embodiment;

FIG. 3 is a schematic representation of a detail of the post-treatment area of FIG. 2 according to one embodiment;

FIG. 4 is a schematic perspective representation of the post-treatment area of FIGS. 2 and 3 in a further perspective view according to one embodiment;

FIG. 5 is a schematic representation of a detail of the post-treatment area, comprising a tripping elevation for displacing containers accommodated in container baskets or container pockets according to one embodiment; and

FIG. 6 is a representation of nozzles attached to a lower plate of a pressure tube by means of flanging according to one embodiment.

### DETAILED DESCRIPTION

Examples of embodiments are described below with the aid of the figures. In the figures, elements which are identical or similar, or have identical effects, are designated with identical reference signs, and repeated description of these elements is in part dispensed with in the description below, in order to avoid redundancy.

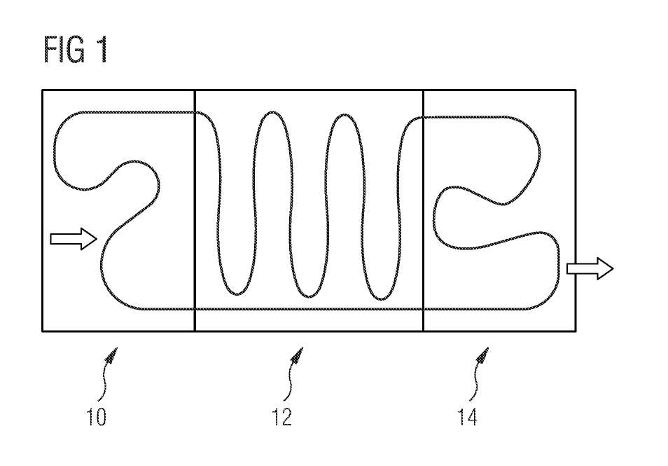

FIG. 1 shows schematically the structure of a device 1 for cleaning containers, here in the form of a double-end bottle cleaning machine, according to one embodiment. In a pre-treatment area 10, the containers to be cleaned are fed into device 1 in the direction indicated by the arrow, wherein, in the pre-treatment area 10, for example the upending of the containers takes place, such that remaining product residue can flow out and loose extraneous material can fall out In the pre-treatment area 10, the containers are also flushed with water jets or pre-lye jets, and the warming or pre-warming of the bottles is carried out, for example by the use of pre-lye of gradually increasing warmth, or water of gradually increasing warmth.

After passing through the pre-treatment area 10, the containers reach a main treatment area 12, in which the containers are immersed in a main lye bath where the separation of contaminants, foreign matter and residues of product from the outside and inside of the containers to be cleaned is performed. The containers are repeatedly immersed in the main lye (or other cleaning solutions as desired), and, after the containers are completely filled with the main lye, the draining of all of the main lye from the containers is again achieved by means of the conveyance of the containers along a meandering path. The contaminants are removed by means of this alternation of immersion of the containers in the main lye and drainage of the main lye from them. In the main treatment area 12, a flushing device can also be provided, where, by means of applying a stronger flow, the relative movement between the lye and the container to be cleaned is increased, so that efficient cleaning of the containers is made possible by means of the mechanical impulsive component that is applied.

In a post-treatment area 14, which the containers reach after passing through the full extent of the main treatment area 12, subsequent cleaning of the containers is carried out by means of a post-lye bath, and the containers are slowly cooled to the ambient temperature. In the post-treatment area 14, the containers are also rinsed with jets of pure water (or other suitable liquids), so that fully cleaned containers are supplied at the outlet, and can be conveyed to their further processing.

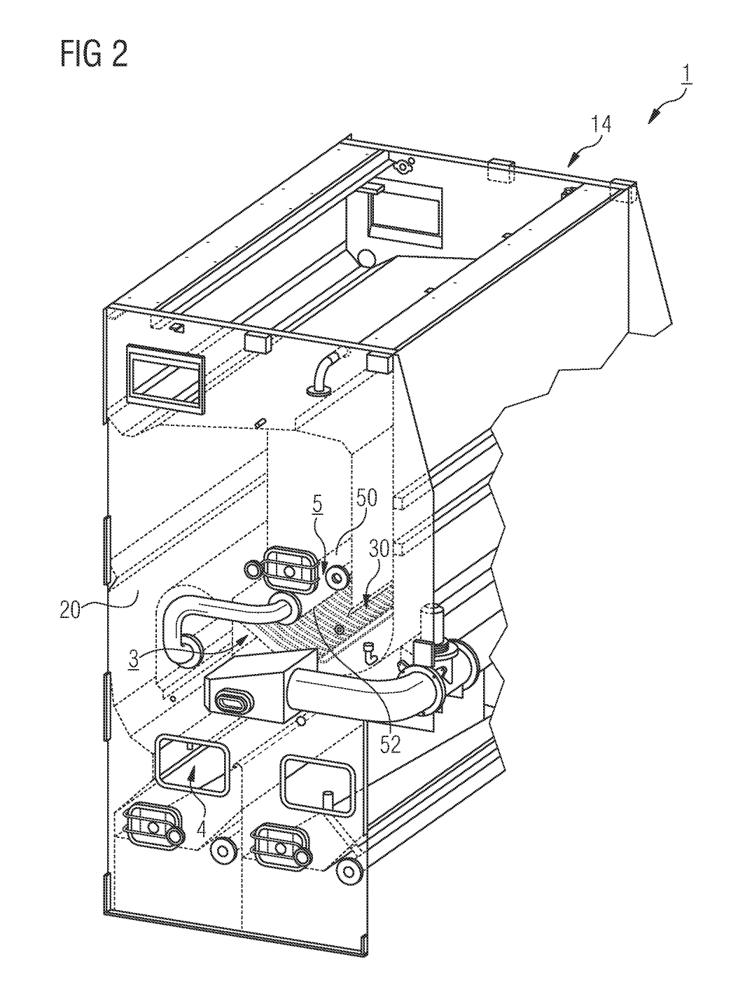

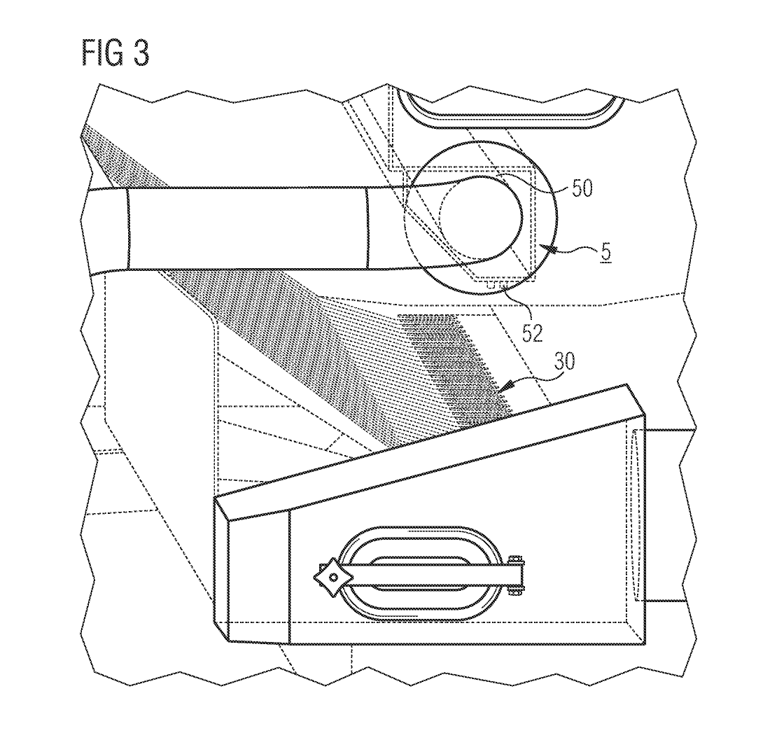

FIGS. 2 to 5 show different aspects of a device 1. These figures each show details of the post-treatment area 14.

In accordance with various embodiments, the containers pass through a water bath or post-lye bath 20, indicated schematically, in which a label removal device 3 is provided. The label removal device 3 is configured such that the containers, which are conveyed in container baskets, are conveyed across a suitable bottle grid 30 with the openings of the container baskets or container pockets facing downwards. The bottle grid 30 serves to draw away, in a downwards direction, the labels that are removed from the bottle baskets in the area of the label removal device 3, and also enables any glass fragments or dirt to be discharged in a downwards direction. The label removal device 3 is accordingly integrated with a glass fragment removal device 4, which is shown only schematically.

In the area of the label removal device 3, a flushing device 5 is provided, in such a manner that it provides a flow directed downwards from above in the area of the bottle grid 30. This flow is generated in the water bath or post-lye bath 20 by means of a pressure tube 50 which has pressure nozzles 52 oriented downwards. Thus the individual nozzles 52 of the flushing device 5 are oriented such that they emit the fluid downwards, i.e. they are oriented towards the bottle grid 30. In this manner it is possible to generate a flow in the water bath or post-lye bath 20 which is directed downwards from above in the direction of the bottle grid 30, and which accordingly flows through the container baskets or container pockets whose openings face downwards. By this means, labels or other foreign matter still in or on the containers, container baskets or container pockets can be flushed away in a downwards direction.

The nozzles 52 are, in one embodiment, disposed such that they emit the fluid below the level of the fluid in the post-lye bath 20. In this manner, excessive formation of foam can be counteracted.

The nozzles 52 are disposed across the width of the machine in the positions in which the containers are conveyed through the machine in container baskets or container pockets. In other words, at least one nozzle 52 is provided for each container position, so that all containers and container baskets or container pockets can be subjected to a substantially homogeneous flow of fluid. In one embodiment, a plurality of nozzles 52 are also disposed one after the other in the direction of movement of the containers, so that the flushing effect in the flushing device 5 can thereby act upon the containers over a certain period of time.

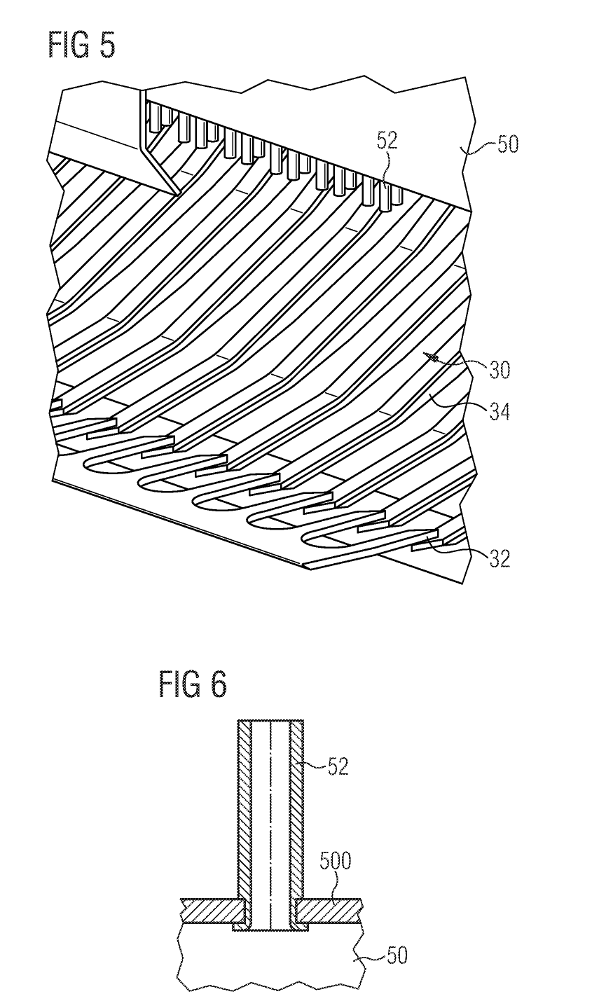

In the embodiment shown, the pressure tube 50 is in the form of a box-shaped channel (although channels of other shapes may also be suitable), on the underside of which the nozzles 52 are disposed. By means of the box-shaped design, the formation of dead zones in the post-treatment area 14 is avoided, with the result that all areas in the post-treatment area 14 can be cleaned by the post-lye and/or by a flow that cleans the cleaning device. Furthermore, the nozzles, as shown for example in FIG. 6, can be attached to the lower plate 500 of the pressure tube 50 by means of flanging, thus enabling simple attachment of the nozzles 52.

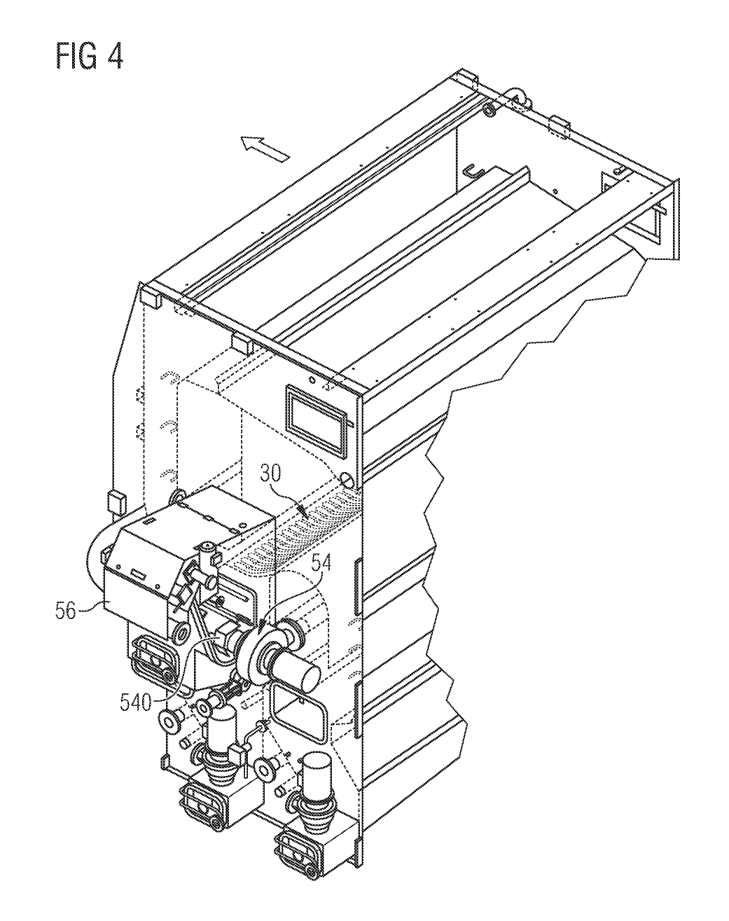

Below the bottle grid 30, as can be seen for example in FIG. 4, a suction device 54 in the form of a pump is provided in one embodiment, which extracts the fluid flow that is applied via the nozzles 52, pressurizes it, and returns it to the pressure tube 50. This accordingly enables, in the area of the bottle grid 30, the formation of a fluid flow directed downwards from above, which is in the direction of and exactly parallel to the container baskets or container pockets, whose openings face downwards. By this means, efficient flow though the container baskets or container pockets can be achieved.

In order to feed the nozzles 52 in the pressure tube 5, an additional suction device 54 in the form of a pump is necessary. This suction device 54, which can be seen for example in FIG. 4, is laterally flange-mounted in the area of the label removal device 56. By means of the proposed flushing in the post-treatment area 14, and in particular by means of flushing with the post-lye, any labels and other extraneous materials still present after the main treatment are removed from the interior or exterior of the containers, container baskets or container pockets. By this means, disruptions are substantially avoided in the subsequent water zones, in which the containers are treated with clear water and pure water.

Furthermore, this also avoids a lengthening of the main treatment, which could be envisaged as an alternative procedure, so that that the treatment times remain short and the device as a whole can be kept compact. This results in fewer disruptions in the operation of the device, achieved with only a small additional expense for the provision of the post-lye flushing in the post-treatment area.

In order to avoid the creation of a vortex in the intake area of the pump 54, a baffle plate 540 is provided, which prevents the formation of such a hollow vortex.

FIG. 4 additionally shows, at the side of the bottle grid 30, the actual label extractor 56, by means of which the labels are removed from the cleaning device.

FIG. 5 again shows the bottle grid 30 in a schematic representation, in which the pressure tube 50 with the nozzles 52 is shown above the bottle grid 30. The bottle grid 30 has a tripping step 32, which is formed in that the end of the grid is lowered in the direction of movement of the containers, so that a step is produced, which forms the tripping step 32. In order to prevent deflection of the ends of the bottle grid 30, stiffening plates 34 are provided underneath the grid ends, helping to reinforce them.

By means of the embodiment shown, in which the pump 54 is disposed below the bottle grid 30, there is also automatically a volume flow of the water or lye in the water bath or lye bath 20 in the direction of the label extractor 56, so that the labels that are drawn through the bottle grid 30 into the channel beneath it are at the same time transported to the label extractor 56.

In conventional systems, in which only the removal of glass fragments takes place in the glass fragment channel, and there is accordingly a cross-flow, i.e. a flow that is guided transversely to the direction of transport of the bottles to be cleaned, an additional volume flow in a transverse direction is also applied above the removal grid by means of the division of the volume flow. This transverse volume flow according to the conventional design cannot, however, achieve the flushing out of labels that are still being carried along in the container baskets or container pockets.

By means of the proposed flushing-through of the container baskets or container pockets in a direction in which the fluid flow is directed towards the open end of each container basket or container pocket, it is possible to achieve the complete removal of all extraneous material, in particular including the labels. This is achieved by disposing the flushing device 5 in the post-treatment area 14 at the latest possible moment in the processing cycle, so that even stubborn combinations of labels, adhesives and containers can eventually be soaked sufficiently that complete removal of the labels is possible. In order to be able also to remove easily the labels that are trapped between the container pocket or container basket and the container itself, a tripping step 32 is provided, on which the container is displaced within the container pocket or container basket, for example by means of tipping which is effected by the tripping step 32, so that the trapped labels can then be flushed out. The tripping step 32 is accordingly disposed in an area in which the proposed flushing, and in particular the volume flow directed downwards from above, is provided.

To the extent applicable, all individual features described in the individual example embodiments can be combined with each other and/or exchanged, without departing from the field of the invention.

What is claimed is:

1. A system for cleaning containers comprising:
a first treatment area configured to receive containers and treat containers with lye; and
a second treatment area configured to receive containers from the first treatment area and treat container with water, wherein the second treatment area comprises a flushing device configured for removing labels and/or residues of labels from the containers.

2. The system of claim 1, wherein the first treatment area comprises a lye bath.

3. The system of claim 1, further comprising a third treatment area configured to remove residue material from containers prior to treatment in the first treatment area.

4. The system of claim 1, wherein the flushing device is disposed in a water bath or post-lye bath.

5. The system of claim 1, wherein the flushing device is configured to generate a directed flow of fluid in a water bath or post-lye bath to flow around the containers.

6. The system of claim 5, wherein the flushing device is further configured to generate a directed flow of fluid out of a container basket or container pocket which holds one container.

7. The system of claim 1, wherein the second treatment area comprises a label removal device.

8. The system of claim 1, wherein the flushing device comprises at least one nozzle for each container position.

9. The system of claim 8, wherein the at least one nozzle for each container position is oriented to emit a directed fluid flow below a level of a fluid in a water bath or a post-lye bath in the second treatment area.

10. The system of claim 8, wherein the at least one nozzle for each container position is oriented to emit a directed fluid flow downwards.

11. The system of claim 1, wherein the second treatment area further comprises a removal grid disposed below the flushing device.

12. The system of claim 11, wherein a directed fluid flow from the flushing device is directed onto the removal grid.

13. The system of claim 1, wherein the second treatment area further comprises a glass fragment removal device configured to remove detached labels or parts of labels.

14. The system of claim 1, wherein the second treatment area further comprises a tripping step configured to tip a container disposed in a container pocket or a container basket.

15. The system of claim 14, wherein the tripping step is disposed in an area of the flushing device.

16. A method for cleaning containers, comprising:
cleaning a container in with lye in a first area;
treating the container with a post-lye or water in a second area separate from the first area; and
flushing the container in the second area.

17. The method of claim 16, wherein the cleaning is in a lye bath.

18. The method of claim 16, wherein the flushing comprises directing fluid into an open end of the container.

19. The method of claim 18, wherein the fluid comprises water.

20. The method of claim 1, wherein the cleaning, the treating, and/or the flushing comprises inverting the container so that an open end of the container is facing downward.
